(19) United States
(12) Patent Application Publication
(10) Pub. No.: US 2013/0191724 A1
(43) Pub. Date: Jul. 25, 2013

(54) Process of Generation of Personal Web Pages

(71) Applicant: LoginPeople SA, Valbonne (FR)

(72) Inventor: Olivier Locufier, Valbonne (FR)

(73) Assignee: LOGINPEOPLE SA, Valbonne (FR)

(21) Appl. No.: 13/790,551

(22) Filed: Mar. 8, 2013

Related U.S. Application Data
(63) Continuation of application No. PCT/EP2011/004515, filed on Sep. 8, 2011.

(30) Foreign Application Priority Data
Sep. 9, 2010 (FR) 10/03602

(51) Int. Cl. G06F 17/21

(52) U.S. Cl. CPC G06F 17/211
USPC 715/234

(57) ABSTRACT

A process for the generation of web pages to the attention of the software navigator of an information system (I.H.S.) including:
the reception of a request for connection coming from the I.H.S. system
the generation of a web page comprising an executable code executing the following operations:
a detection of the hardware components accessible by the operating system, in to particular the information for the installation of pilots;
the chopping of this information in order to generate digital information of reference characterizing the connected system;
the transmission of this digital information of reference to the web server;
the storage of said digital information of reference within the web server.

This application is a continuation of International Application No. PCT/EP2011/004515, filed on Sep. 8, 2011, and herein incorporated by reference in its entirety.

### TECHNICAL FIELD

The present invention relates to the field of communications on the Internet network, and especially to a process of generation of personal web pages.

### BACKGROUND ART

The development of the trade on the Internet network leads the owners of sites of online trade to present increasingly sophisticated solutions in order to ensure the development of their activity.

Commercial web sites, which at the early years were basically “on-line” catalogues of products offered for sale, have recently be moved to highly sophisticated tools for attracting the itinerant consumer, to entice him/her to remain as long as possible on the web site and, eventually to finalize a purchase operation.

To achieve such goal, the web site editors try to customize as much as possible the presentation of the web site in accordance with the profiles of the different consumers which are likely to visit, at one moment or another, the web portal.

A well-known technique allowing this personalization is based on the use of the cookies, namely an identification element the web browser keeps within the user machine for the purpose, during a subsequent visit, to recognize the user in order to create a well tailored home page corresponding to his/her profile.

This technique has known a significant development and shows clear drawbacks.

Firstly, the web servers and the Internet consumers have become particularly reluctant on the idea of leaving “traces” in their machine and became particularly sensitive to the presence of such residual “cookies”. They do not hesitate to erase them or make them to be erased by using their anti-virus software.

Secondly, the system of the cookies is particularly criticized today and it would be highly desirable to be able to substitute it with another less “visible” technique, which would not leave any trace on the machine of the consumers.

Such is the aim of the present application.

### SUMMARY

The purpose of the present invention is to carry out a process allowing a tailored construction of web page intended to a web browser so as to improve the presentation of a web site to consumers and Internet surfers.

Another object of the present invention consists in proposing a process facilitating the follow-up of the navigation of a user of a given Internet site.

It is another object of this invention to provide a process improving the personalization of Internet pages transmitted to the consumers in a respectful way for the private life of the latter.

The invention achieves these goals by means of a process of generation of web pages to the attention of the software navigator of an information system (I.H.S.) including:
receipt of a connection request emanating from said I.H.S. system
generation of a web page comprising an executable code carrying out the following operations:
a detection of the hardware components accessible by the operating system, in particular the information for the drivers installation;
the hashing of this information in order to generate digital information of reference characteristics of the connected system;
the transmission of this digital information of reference to said web server;
the storage of said digital information of reference within the server.

In a particular embodiment, the process comprises the development of a personal web page according to said digital information of reference stored on said server.

Preferably, the executable code is transmitted in the form of a client application, such as a java applet or a plug-in, present on the machine of the Net surfer.

Preferably, said DDNA digital information of reference (digital DNA) is stored within a database present on the web server and compared with information of references presented later on.

In a particular embodiment, said information system is a computer, a laptop, a device of the P.D.A. (Portable Assisting Document) type, or a cell phone.

The invention also allows the achievement of a device allowing the generation of Web pages designated for Internet network and consultable by means of a system of information processing (I.H.S.), said device comprising:
means of receiving a request for connection from said I.H.S. system
means of generation (20) of a web page comprising an executable code said code carrying out the following operations:
a detection (30) of digital components accessible by the operating system, in particular the information for the installation of the pilots;
the chopping (40) of this information in order to generate digital information of reference characterizing the connected system;
the transmission (50) of this digital information of reference to that web server;
a database allowing the storage of a digital information of reference (DDNA) associated with the preferences of the user.

### DESCRIPTION OF THE DRAWINGS

Other features, objects and advantages of the invention will appear with the reading of the description and the drawings hereafter, only being given as nonrestrictive examples. On the annexed drawings:

FIG. 1 illustrates an system architecture that comprises multiple material components.

### DESCRIPTION OF A PREFERRED EMBODIMENT

It will now be described an alternative process and method for storing users preferences and options during their visiting web sites.

One should noticed that the device of access to the Internet network could be any particular device, and in particular a computer, a laptop, a personal assistant being designated in the Anglo-Saxon literature under the name Portable Document Assistant (PDA), and even a mobile phone such as a 3G telephone according to the 3GPP specifications.

Generally speaking, the invention is applicable to any system of data processing—conventionally designated under the general name of Information Handling System (I.H.S.)—and based on a processor 101 executing an operating is system such as Windows 7 or Windows XP (marketed by the Microsoft Corp. company) or LINUX, to which it is connected a set of hardware and peripheral components, such as a graphic card, a network card, components of the USB type (Universal Serial Bus) . . . .

The device comprises means of communication giving access to the Internet network and in particular to a software browser allowing Internet surfing.

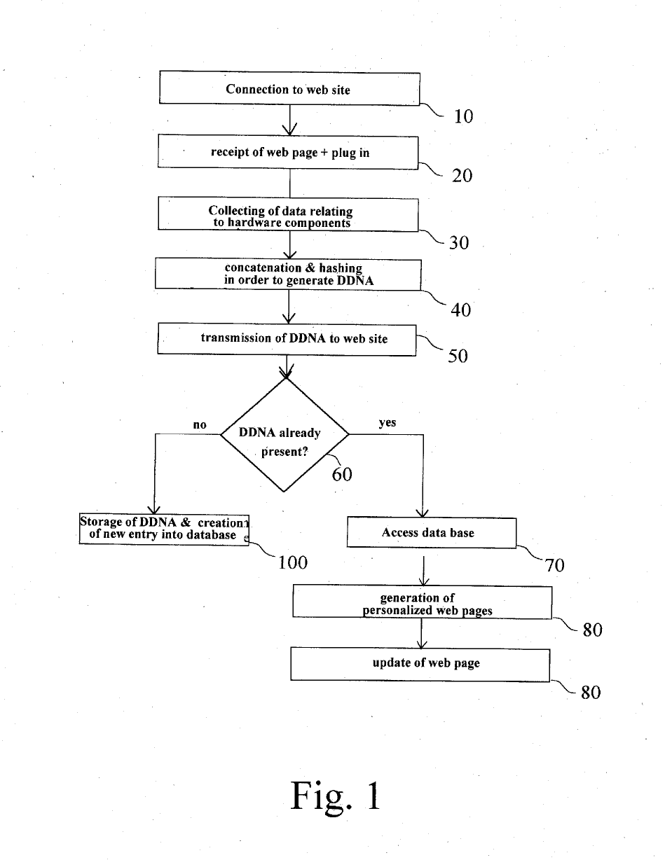

One will now describe, in relation to FIG. 1, one particular embodiment of a process according to the invention.

In a step 10, the process starts with the connection to the Internet network and in particular to a determined web site.

Then, in a step 20, the system receives a web page, which could for example be a response of the type 200 according to the HTTP (Hypertext Transfer Protocol) protocol or any other home page, accompanied by an executable code in the form, for example, of a java applet or a plug-in.

Alternatively, one will be able to consider a secured or a non secured connection for the reception of the page of the web site.

Then the process proceeds, in a step 30, with the execution of the java applet, which applet engages an identification procedure of the hardware components present in the system of the user, and in particular transferred by the operating system.

Generally speaking, one will be able to be largely inspired by the existing to developments in the pre cited European patent application 04368072.7 (counterpart U.S. Pat. No. 7,877,614), which gives examples of suitable components which can be used. A described in this patent application, a great number of information concerning the different hardware components are transferred and available to the operating system, that is related to WINDOWS under its various versions (XP, VISTA, WINDOWS 7 . . . ) or LINUX etc, in particular in order to allow the loading of the necessary pilots to the interfacing of the operating system with these components. The contribution of the above mentioned request, consists in gathering this significant information, initially designated to the “internal” operation of the component, in order to constitute a file comprising the data concatenation and representative parameters of the different hardware components of the system.

Thus, in the case of a conventional USB key, one raises that up to 43 characteristics (the mark, the model, the serial number, the size memory . . . etc . . .) are accessible to the operating system and could be integrated for the generation of digital information of reference (DDNA).

The digital information of reference (DDNA) is generated in a step 40 by means of hash of the “raw” information being collected during step 30.

In particular one will be able to use the various available hash algorithms, in particular the algorithms such as MD4, MD5 developed by Ronald Rivest, and SHA of NIST.

The aim being that the use of the hashing process should prevent any hacking to retrieve the original information representative of the various hardware components of the computer of the user.

The digital information of reference—the digital DNA—could then be transferred by the applet to the web site during a step 50.

Then the process proceeds to a verification during a step 60 intended to ensure that the DDNA information does not already appear in a local database present in the server, in which case the process continuous with a step 70.

In the step 70, the process accesses the database in order to find again the preferences and the user profile data.

Then the process proceeds to a stage 80 with the creation of well tailored web pages, by taking account the user's profile as the latter surfers on the considered web site.

At the end of the browsing, the process continues with a step 90 corresponding to the update of the profile database.

On the assumption that the verification of the step 60 has lead to the observation that the user was not already registered in the profile database, the process creates a new entry within the base in a step 100 and stores there the digital information of reference DDNA for being able to find it again later on.

Thus it is found that the confidentiality of the composition of the user's computer since the editors of the web site will be able to have only one hash, that is to say one “fingerprint” which will in no way allow to find again original information having been used to carry out the digital information of reference (digital DNA).

As it is seen, the process that is described allows to achieve a right balance between the interests of the consumer and those of the editors of the Internet site.

The consumers and the net surfers are indeed assured that no confidential information—even bearing on the “composition” of the system—will be transmitted to the site of trade. Moreover, no trace of the visit of the web site will not be present on the computer at the end of the visit.

The site of trade will have minimal information, namely the digital information of reference (digital DNA), which will enable him to store the consumer's preferences and, consequently, to present a site of trade more adapted and more personalized.

In addition, another advantage of the present invention lies in the fact that it is not any more necessary to store sensitive information in the cookies usually present in the machines of the consumers and which, in that way are particularly exposed to the attacks of the badly intentioned hackers.

1. A method for generating web pages for a web browser of an information system (I.H.S.) comprising:
receiving a request for connection coming from said I.H.S. system
generating a web page comprising an executable code executing the following operations:
detecting the hardware components available through the operating system, in particular comprising information relative to the components drivers;
hashing of this information in order to generate digital information of reference characteristics of the connected system;
transmitting this digital information of reference to a web server;
checking in order to determine whether said digital information of reference is present in a database of the web server;
accessing said database if the verification (60) is positive; and
personalizing a web page in accordance with said digital information of reference present on said web server.

2. The method for generating web pages for a web browser of an information system (I.H.S) according to claim 1 wherein the storage of said digital information of reference within the web server if the verification is negative.

3. The method for generating web pages for a web browser of an information system (I.H.S) according to claim 1 wherein said executable code is transmitted in the form of a client application, such as a java applet or a plug-in.

4. The method for generating web pages for a web browser of an information system (I.H.S) according to claim 1 wherein said digital information of reference is stored within a database present on the web server and compared with information of references being subsequently presented.

5. The method for generating web pages for a web browser of an information system (I.H.S) according to claim 2 wherein said digital information of reference is stored within a database present on the web server and compared with information of references being subsequently presented.

6. The method for generating web pages for a web browser of an information system (I.H.S) according to claim 3 wherein said digital information of reference is stored within a database present on the web server and compared with information of references being subsequently presented.

7. The method for generating web pages for a web browser of an information system (I.H.S) according to claim 1, wherein said information system is a computer, a laptop, a P.D.A. (Portable Assisting Document) device, or a mobile phone.

8. The method for generating web pages for a web browser of an information system (I.H.S) according to claim 2 wherein said information system is a computer, a laptop, a P.D.A. (Portable Assisting Document) device, or a mobile phone.

9. The method for generating web pages for a web browser of an information system (I.H.S) according to claim 3, wherein said information system is a computer, a laptop, a P.D.A. (Portable Assisting Document) device, or a mobile phone.

10. A Device allowing the generation of a web page intended for Internet network and consultable by means of a system of information processing (I.H.S.), said device including:
means for receiving a request for connection issued by said I.H.S. system
means for generation a web page comprising an executable code said code executing the following operations:
a detection of the hardware components accessible by the operating system, in particular the information for the installation of the pilots;
a hashing of this information in order to generate a digital information of reference characterizing the connected system;
the transmission of this digital information of reference to said web server;
a database allowing the storage of digital information (DDNA) of reference associated with preferences of the user.
means for checking whether said digital information of reference is present in a database of the web server;
means for access said database if said checking is positive;
means for personalizing a web page according to said digital information of reference present on said web server.

11. The Device according to claim 6 wherein it comprises means of storage of said digital information of reference within the web server if the verification is negative.

12. The Device according to claim 6 wherein said executable code is transmitted in the form of a java applet or a plug-in.
